(19) United States
(12) Patent Application Publication
(10) Pub. No.: US 2026/0011888 A1
(43) Pub. Date: Jan. 8, 2026

(54) ELECTRODE ASSEMBLY AND SECONDARY BATTERY MANUFACTURED USING SAME

(71) Applicant: SAMSUNG SDI CO., LTD., Yongin-si (KR)

(72) Inventor: Kyeong-Yun PARK, Yongin-si (KR)

(21) Appl. No.: 19/083,313

(22) Filed: Mar. 18, 2025

(30) Foreign Application Priority Data
Jul. 5, 2024 (KR) 10-2024-0089090

(51) Int. Cl. H01M 50/586; H01M 10/04

(52) U.S. Cl. CPC H01M 50/586; H01M 10/0431

(57) ABSTRACT

Embodiments of the present disclosure are directed to an electrode assembly. The electrode assembly includes an electrode stack formed in a wound structure, the electrode stack including a first electrode, a separator, and a second electrode, and a first insulating member and a second insulating member attached to the electrode stack. The electrode stack includes a first side having a first rounded portion, a second side having a second rounded portion, and a third portion formed between the first rounded portion and the second rounded portion. Further, the first insulating member and the second insulating member are attached to a lower part of the third portion.

### CROSS-REFERENCE TO RELATED APPLICATION

The present application claims priority to and the benefit of Korean Application No. 10-2024-0089090, filed on Jul. 5, 2024, in the Korean Intellectual Property Office, the entire disclosure of which is incorporated by reference herein.

### BACKGROUND

### 1. Field

Aspects of embodiments of the present disclosure relate to an electrode assembly and a secondary battery manufactured using the electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The electrode assembly may be classified into a stack-type electrode assembly in which a positive electrode plate, a separator, and a negative electrode plate are sequentially stacked, and a winding-type electrode assembly in which a positive electrode plate, a separator, and negative electrode plate are sequentially stacked and wound. In the case of the winding-type electrode assembly, the expansion and contraction of the electrode assembly may be repeated during charge and discharge cycles of the secondary battery. This may cause the formation of cracks on a surface(s) of the electrode assembly.

The above information disclosed in this Background section is for enhancement of understanding of the background of the present disclosure, and therefore, it may contain information that does not constitute related (or prior) art.

### SUMMARY

Aspects of embodiments of the present disclosure provide an electrode assembly and a secondary battery manufactured using the electrode assembly.

These and other aspects and features of the present disclosure will be described in or will be apparent from the following description of embodiments of the present disclosure.

An electrode assembly according to some embodiments of the present disclosure includes an electrode stack formed in a wound structure, the electrode stack including a first electrode, a separator, and a second electrode; and a first insulating member and a second insulating member attached to the electrode stack. The electrode stack includes a first side having a first rounded portion, a second side having a second rounded portion, and a third portion formed between the first rounded portion and the second rounded portion. Further, the first insulating member and the second insulating member are attached to a lower part of the third portion.

According to some embodiments of the present disclosure, the first insulating member may be spaced apart from an apex of the first rounded portion by a first length, the second insulating member may be spaced apart from an apex of the second rounded portion by a second length, and each of the first length and the second length may be in a range from approximately 7 mm to approximately 8 mm.

According to some embodiments of the present disclosure, the first insulating member and the second insulating member may be attached to the electrode stack while being spaced apart from each other by a set length in a winding direction of the electrode stack.

According to some embodiments of the present disclosure, the set length between the first insulating member and the second insulating member may be greater or equal to 5 mm.

According to some embodiments of the present disclosure, the first insulating member and the second insulating member may be attached at positions that are symmetrical with respect to a central axis of the electrode stack, the central axis being parallel to a winding axis of the electrode stack.

According to some embodiments of the present disclosure, the first insulating member may be attached to cover at least a portion of each of opposite surfaces of the third portion and a lower surface of the third portion.

According to some embodiments of the present disclosure, a first end of the first insulating member may be positioned on a first surface of the opposite surfaces of the third portion at a first height from the lower surface of the third portion, and a second end of the first insulating member may be positioned on a second surface of the opposite surfaces of the third portion at a second height from the lower surface of the third portion.

According to some embodiments of the present disclosure, each of the first height and the second height may be in a range from approximately 8.5 mm to approximately 9 mm.

According to some embodiments of the present disclosure, the electrode assembly described above may further include a first electrode tab and a second electrode tab that protrude beyond an upper part of the electrode stack; a first electrode tab insulating member attached over the first electrode tab; and a second electrode tab insulating member attached over the second electrode tab.

According to some embodiments of the present disclosure, the first electrode tab insulating member and the second electrode tab insulating member are spaced apart from each other by a set length in a winding direction of the electrode stack.

According to some embodiments of the present disclosure, the electrode assembly described above may further include a second insulating member attached to cover at least a portion of each of opposite surfaces of the third portion and an upper surface of the third portion. Further, the second insulating member may be between the first electrode tab insulating member and the second electrode tab insulating member.

According to some embodiments of the present disclosure, the second insulating member may be located at a set distance from each of the first electrode tab insulating member and the second electrode tab insulating member in a winding direction of the electrode stack.

According to some embodiments of the present disclosure, the set distance between the second insulating member and each of the first and second electrode tab insulating members is greater or equal to 2 mm.

According to some embodiments of the present disclosure, at least a portion of each of the first insulating member and the second insulating member may be formed of a substantially flexible material.

A secondary battery according to some embodiments of the present disclosure includes an electrode assembly including an electrode stack formed in a wound structure, the electrode stack including a first electrode, a separator, and a second electrode; and a first insulating member and a second insulating member attached to the electrode stack; and a case accommodating the electrode assembly. The electrode stack includes a first side with a first rounded portion, a second side having a second rounded portion formed at a second side portion thereof, and a third portion formed between the first rounded portion and the second rounded portion. Further, the first insulating member and the second insulating member are attached to a lower part of the third portion.

According to some embodiments of the present disclosure, the first insulating member may be spaced apart from an apex of the first rounded portion by a first length, the second lower insulating member may be spaced apart from an apex of the second rounded portion by a second length, and each of the first length and the second length may be in a range from approximately 7 mm to approximately 8 mm.

According to some embodiments of the present disclosure, the first insulating member and the second insulating member may be attached to the electrode stack while being spaced apart from each other by a set length in a winding direction of the electrode stack.

According to some embodiments of the present disclosure, the set length between the first insulating member and the second insulating member may be greater or equal to 5 mm.

According to some embodiments of the present disclosure, the first insulating member and the second insulating member may be attached at positions that are symmetrical with respect to a central axis of the electrode stack, the central axis being parallel to a winding axis of the electrode stack.

According to some embodiments of the present disclosure, the first insulating member may be attached to cover at least a portion of each of opposite surfaces of the third portion and a lower surface of the third portion.

According to some embodiments of the present disclosure, the lower insulating members can disperse the stresses concentrated at the rounded portions of the electrode stack and/or the portions where the rounded portions meet the third portion, thereby preventing the formation of cracks on the surface(s) of the electrode stack.

According to some embodiments of the present disclosure, a secondary battery manufactured using the electrode assembly to which the lower insulating members are attached can exhibit improved stability and lifespan characteristics of the secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates an example battery cell according to one embodiment of the present disclosure.

FIG. 2 illustrates a side view of an example electrode assembly according to one embodiment of the present disclosure.

FIG. 3 illustrates a bottom plan view of an example electrode assembly according to one embodiment of the present disclosure.

FIGS. 4A-4C depict images of an electrode assembly with lower insulating members respectively attached at different distances from opposite side edges of the electrode assembly.

FIG. 5 illustrates a side view of an example electrode assembly according to one embodiment of the present disclosure.

FIG. 6 illustrates a side view of an example electrode assembly according to one embodiment of the present disclosure.

FIG. 7 illustrates a top plan view of an example electrode assembly according to one embodiment of the present disclosure.

FIG. 8 illustrates a side view of an example electrode assembly according to one embodiment of the present disclosure.

FIG. 9 illustrates a perspective view of an example electrode assembly according to one embodiment of the present disclosure.

FIG. 10 illustrates a table representing example internal resistance measurement results of a secondary battery according to one embodiment of the present disclosure.

FIG. 11 depicts images of a secondary battery after undergoing a crack inspection according to one embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the sizes and the relative sizes of the layers and regions shown in the drawings may be exaggerated for the sake of clarity of explanation. That is, the sizes shown in the drawings are for the sake of convenience of understanding and are not intended to limit the scope of the present disclosure. Further, throughout the specification, like reference numerals refer to like parts.

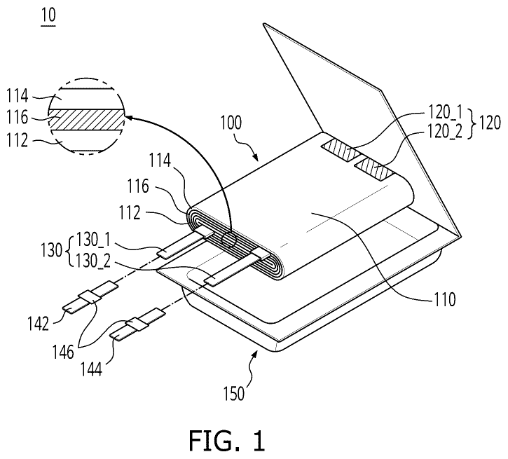

FIG. 1 illustrates an example of a battery cell 10 according to one embodiment of the present disclosure. As shown in FIG. 1, the battery cell 10 may include a case 150 and an electrode assembly 100 disposed or located within the case 150.

The electrode assembly 100 may include an electrode stack 110. The electrode stack 110 may include a first electrode 112, a second electrode 114, and a separator 116 interposed between the first electrode 112 and the second electrode 114. The first electrode 112 and the second electrode 114 may be wound with the separator, which is an insulator, interposed therebetween. The first electrode 112 of the electrode stack 110 may serve as a negative electrode, and the second electrode 114 may serve as a positive electrode. In some embodiments, the roles can be reversed.

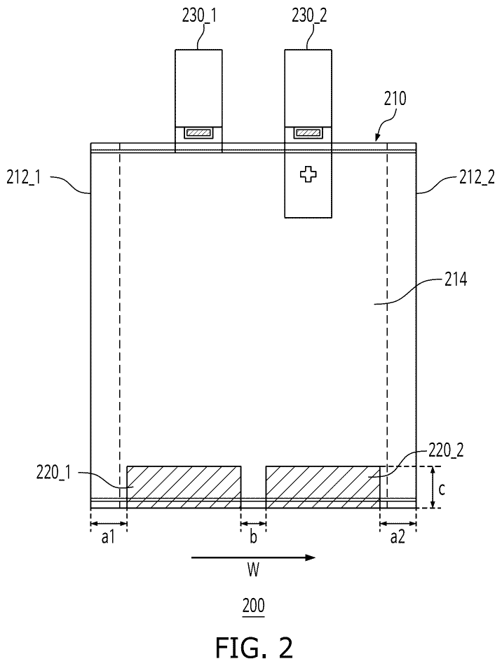

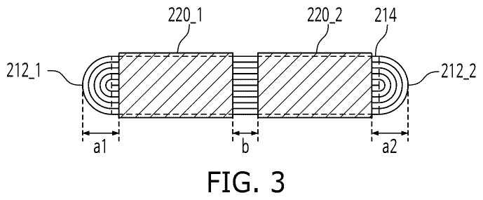

The electrode assembly 100 may include a lower (first) insulating member 120. The lower insulating member 120 may be attached to a lower part of the electrode stack 110. For the convenience of explanation, a region of the electrode stack 110 where an electrode tab 130 is formed will be referred to as an upper part of the electrode stack 110, and a region of the electrode stack 110, which is opposite to the region where the electrode tab 130 is formed, will be referred to as the lower part of the electrode stack 110. The lower insulating member 120 may be attached so as to cover (e.g., wrap around) at least a portion of each of the opposite side surfaces (e.g., front and rear surfaces of the electrode stack 110) and a lower surface of the electrode stack 110. Specific examples of the lower insulating member 120 will be described in detail later with reference to FIGS. 2 and 3.

The first electrode 112 may be formed by applying an active material, such as graphite or carbon, onto a substrate formed of a metal foil, such as copper, a copper alloy, nickel, or a nickel alloy. The first electrode 112 may include an uncoated portion that is a region onto which the active material is not applied. A first electrode tab 130_1 may be connected to the uncoated portion of the first electrode 112. The first electrode tab 130_1 may serve as a current flow path between the first electrode 112 and a first lead tab 142. A tab film 146 may be attached to the first lead tab 142 for insulation from the case 150.

The second electrode 114 may be formed by applying an active material, such as a transition metal oxide, onto a substrate formed of a metal foil, such as aluminum or an aluminum alloy. The second electrode 114 may include an uncoated portion that is a region onto which the active material is not applied. The second electrode tab 130_2 may be connected to the uncoated portion of the second electrode 114. The second electrode tab 130_2 may serve as a current flow path between the second electrode 114 and a second lead tab 144. The tab film 146 may be attached to the second lead tab 144 for insulation from the case 150.

The case 150 may form the overall outer appearance of the battery cell 10 and may be made of a conductive metal, such as aluminum, an aluminum alloy, or a nickel-plated steel. In addition, the case 150 may provide a space in which the electrode assembly 100 is accommodated. In the embodiment of FIG. 1, a pouch-type case and a pouch-type battery cell are illustrated as the case 150 and the battery cell 10, respectively. However, the scope of the present disclosure is not limited thereto, and the battery cell 10 may be a battery cell of any shape, such as a prismatic shape, a cylindrical shape, or a pouch-shape.

The battery cell 10 may be a type of secondary battery. For example, the battery cell 10 may be a lithium battery cell, a sodium battery cell, or the like. However, the scope of the present disclosure is not limited thereto, and the battery cell 10 includes any battery capable of repeatedly providing electrical power through charge and discharge cycles.

FIG. 2 illustrates a side view of an example electrode assembly 200 according to one embodiment of the present disclosure. FIG. 3 illustrates a bottom plan view of the example electrode assembly 200 according to one embodiment of the present disclosure. Referring to FIGS. 2 and 3, the electrode assembly 200 may include an electrode stack 210, lower insulating members 220_1 and 220_2 attached to the electrode stack 210, and a first electrode tab 230_1 and a second electrode tab 230_2 protruding beyond the upper part of the electrode stack 210.

The electrode stack 210 may be formed in a wound structure in which the first electrode, the separator, and the second electrode are stacked and wound together. The horizontal cross-section of the electrode stack 210 may have an approximately oblong shape with rounded opposite ends (e.g., a stadium shape). The electrode stack 210 may include a first rounded portion 212_1 formed at a first side or first side portion thereof (e.g., a left side of the electrode stack 210 shown in FIG. 2), a second rounded portion 212_2 formed at a second side or second side portion thereof (e.g. a right side of the electrode stack 210 shown in FIG. 2), and a flat (third) portion 214 formed between the first rounded portion 212_1 and the second rounded portion 212_2.

The lower insulating members 220_1 and 220_2 may be attached to the lower part of the electrode stack 210. The lower insulating members 220_1 and 220_2 may serve to prevent damage to the electrode assembly 200 caused by external impacts, such as the dropping of the secondary cell or the like.

The lower insulating members 220_1 and 220_2 may be attached at positions spaced apart by certain distances from the rounded portions 212_1 and 212_2 located on the opposite side portions (the first and second side portions) of the electrode stack 210, respectively. For example, the first lower insulating member 220_1 may be attached at a distance of a first length a1 from an apex (vertex) of the first rounded portion 212_1, and the second lower insulating member 220_2 may be attached at a distance of a second length a2 from an apex of the second rounded portion 212_2. In some embodiments, the first length a1 and the second length a2 may be the same or different.

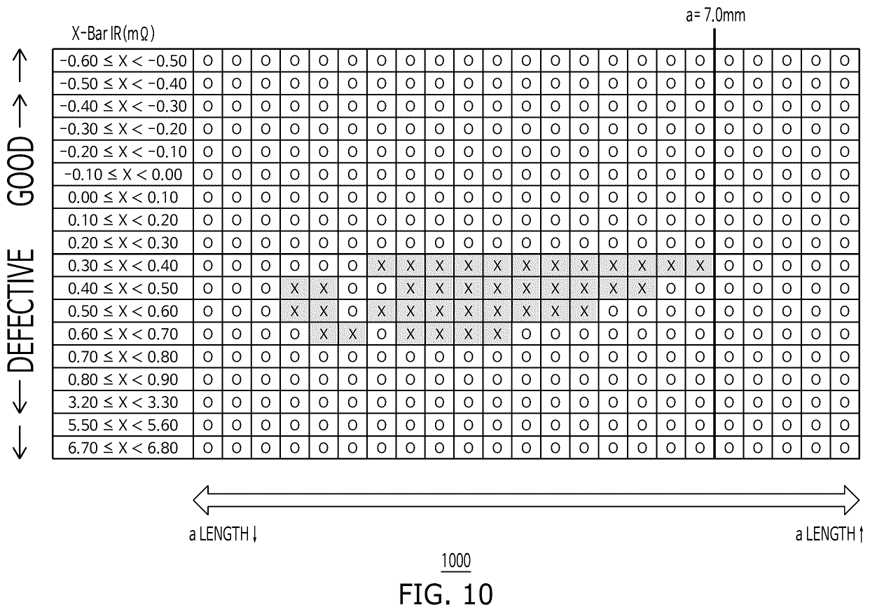

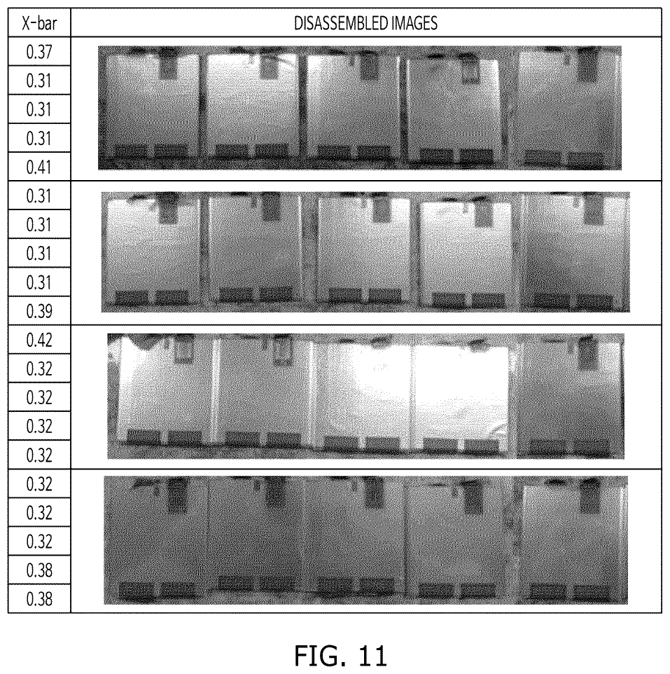

In the embodiment where the first length a1 and/or the second length a2 are smaller than a specific or minimum threshold length, cracks may form on a surface(s) of the lower part of the electrode stack 210 due to contraction and expansion of the electrode assembly 200 during the charging and discharging of the battery cell. In some embodiments, in a case where the first length a1 and/or the second length a2 exceed a specific or maximum threshold length, the separator may wrinkle or curl at the lower part of the electrode stack 210, leading to electrode short-circuiting. To address these issues, the lower insulating members 220_1 and 220_2 are attached at optimized distances from the rounded portions 212_1 and 212_2 of the electrode stack 210, respectively. Each of the first length a1 and the second length a2 may be 7 mm or greater. In some embodiments, the first length a1 and/or the second length a2 is in a range from approximately 7 mm to approximately 8 mm. An example of a method for optimizing an attachment position of each of the lower insulating members 220_1 and 220_2 is described in detail later with reference to FIGS. 10 and 11.

In one embodiment, the first lower insulating member 220_1 and the second lower insulating member 220_2 may be attached to the electrode stack 210 while being spaced apart from each other by a length (e.g., a predetermined or set length) b in a winding direction w of the electrode stack 210. By spacing the first lower insulating member 220_1 and the second lower insulating member 2202 apart from each other, an electrolyte impregnation path may be secured through the lower surface of the electrode stack 210. The length (e.g., the predetermined length) b between the first lower insulating member 220_1 and the second lower insulating member 220_2 may be greater or equal to 5 mm, but is not limited thereto.

In one embodiment, the first lower insulating member 220_1 and the second lower insulating member 220_2 may be attached at positions that are symmetrical with respect to a central axis of the electrode stack 210, where the central axis is parallel to a winding axis of the electrode stack 210. For example, the distance between the first lower insulating member 220_1 and the central axis of the electrode stack 210 may be the same as the distance between the second lower insulating member 220_2 and the central axis of the electrode stack (210), and each of the distances may be at least 2.5 mm, but is not limited thereto.

In one embodiment, the first lower insulating member 220_1 and the second lower insulating member 220_2 may be attached so as to cover at least a portion of each of the opposite side surfaces (e.g., front and rear surfaces) and a lower surface of the flat portion 214. For example, one end of the first lower insulating member 220_1 may be positioned on a first side surface (e.g., the front surface) of the flat portion 214 while the other end of the first lower insulating member 2201 may be positioned on a second side surface (e.g., the rear surface) of the flat portion 214.

In one embodiment, one (e.g., a first) end of the first lower insulating member 220_1 may be positioned on the first side surface of the flat portion 214 at a specific height c from the lower surface of the flat portion 214. The other (e.g., a second) end of the first lower insulating member 220_1 may be positioned on the second side surface of the flat portion 214 at the same height as the specific height c, but is not limited thereto. Similarly, one end of the second lower insulating member 2202 may be positioned on the first side surface of the flat portion 214 at the specific height c from the lower surface of the flat portion 214. The other end of the second lower insulating member 220_2 may be positioned on the second side surface of the flat portion 214 at the same height as the specific height c. The specific height c may be in a range from approximately 8.5 mm to approximately 9 mm, but is not limited thereto.

In one embodiment, at least a portion of each of the lower insulating members 220_1 and 220_2 may be formed of a substantially flexible material. For example, at least a portion of each of the lower insulating members 220_1 and 220_2 may be formed of a material such as polyethylene terephthalate (PET), polyimide (PI), or the like, but is not limited thereto.

With this configuration, the lower insulating members 220_1 and 220_2 can disperse stresses concentrated at the rounded portions 212_1 and 212_2 and/or the portions where the rounded portions 212_1 and 212_2 meet the flat portion 214, to reduce or prevent the formation of cracks on the surface(s) of the electrode stack 210. This may help improve the stability and lifespan characteristics of the secondary battery.

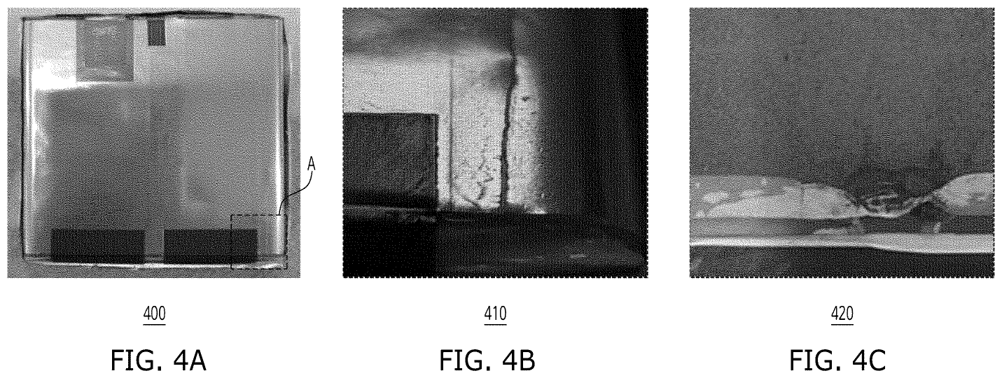

FIGS. 4A-4C are images of an electrode assembly 400 with lower insulating members respectively attached at different distances. In the example of FIGS. 4A and 4B, the lower insulating members are respectively attached at distances less than a specific (e.g., a minimum threshold) length (e.g., less than 7 mm) from the opposite side edges (e.g., apexes of the rounded portions in the example of FIG. 4A) of the electrode assembly 400.

FIG. 4B is an image of a first enlarged view 410 of a marked area A of the electrode assembly 400 The first enlarged view 410 depicts a crack on the surface of the lower part of the electrode assembly 400. During the charge and discharge cycles of the battery cell, repeated expansion and contraction of the electrode assembly 400 may lead to increased stress on the opposite side portions of the electrode assembly 400. If a minimum clearance or distance is not secured between the lower insulating members and the opposite side edges of the electrode assembly 400 (e.g., between a first one of the lower insulating members and a first one of the opposite side edges of the electrode assembly 400, and between a second one of the lower insulating members and a second one of the opposite side edges of the electrode assembly 400), cracks may form on the surface(s) of the lower part of the electrode assembly 400 due to the increased stress on the opposite side portions of the electrode assembly 400 during the charge and discharge cycles of the battery cell.

FIG. 4C is an image of a second enlarged view 420 of an area of the electrode assembly where the lower insulating members are respectively attached at distances greater than a specific length (e.g., exceeding 8 mm) from the opposite sides edges of the electrode assembly. The issue of cracks forming on the surface(s) of the lower part of the electrode assembly may be partially resolved by securing a clearance, space, or gap with a specific separation distance, which is greater than the specific length, between the lower insulating members and the opposite side edges of the electrode assembly. However, if the distances at which the lower insulating members are respectively spaced apart from the opposite side edges of the electrode assembly exceed a specific (e.g., a maximum threshold) length, the separator may begin to curl in regions where the lower insulating members are respectively separated from the opposite side edges of the electrode stack 210 at the lower part of the electrode assembly. In such case, the different electrodes may come into contact, resulting in an electrode short-circuiting. As shown in Table 1 below, the separator may curl when the lower insulating members are respectively attached at distances exceeding 8 mm from the opposite side edges of the electrode assembly.

TABLE 1

| | 7.8 mm | 7.9 mm | 8.0 mm | 8.1 mm | 8.2 mm | 8.3 mm |
|---|---|---|---|---|---|---|
| Occurrence | X | X | X | ◯ | ◯ | ◯ |
| of Separator | | | | | | |
| Curling | | | | | | |

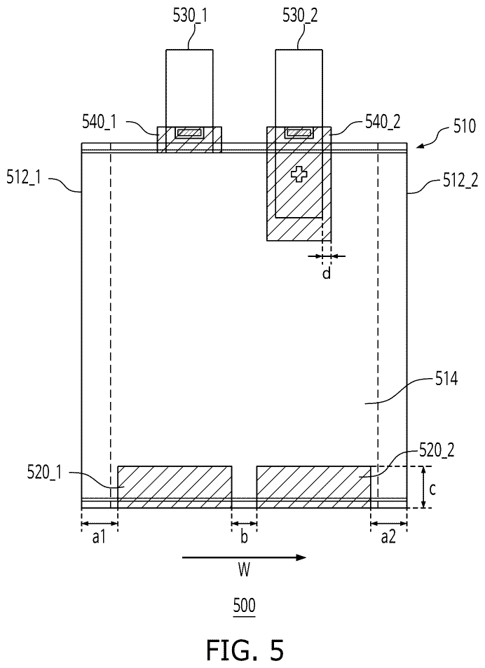

FIG. 5 illustrates a side view of an example of an electrode assembly 500 according to one embodiment of the present disclosure. Referring to FIG. 5, the electrode assembly 500 may include an electrode stack 510, lower insulating members 520_1 and 520_2 attached to the electrode stack 510, first and second electrode tabs 530_1 and 530_2 protruding beyond an upper part of the electrode stack 510, and first and second electrode tab insulating members 540_1 and 540_2 respectively covering (or over) the first and second electrode tabs 530_1 and 530_2.

The electrode stack 510 may be formed in a wound structure in which a first electrode, a separator, and a second electrode are stacked and wound. The horizontal cross-section of the electrode stack 510 may have an approximately oblong shape with rounded opposite ends. The electrode stack 510 may include a first rounded portion 512_1 formed at a first side portion thereof (e.g., a left side of the electrode stack 510 shown in FIG. 5), a second rounded portion 512_2 formed at a second side portion thereof (e.g. a right side of the electrode stack 510 shown in FIG. 5), and a flat portion 514 formed between the first rounded portion 512_1 and the second rounded portion 512_2. A first electrode tab 530_1 may be connected to the first electrode and may protrude beyond an upper part of the electrode stack 510. A second electrode tab 5302 may be connected to the second electrode and may protrude beyond the upper part of the electrode stack 510.

In one embodiment, the first electrode tab 530_1 and the second electrode tab 530_2 may be arranged to protrude at different positions on the upper part of the electrode stack 510. For example, the first electrode tab 530_1 and the second electrode tab 530_2 may protrude beyond an upper surface of the flat portion 514 of the electrode stack 510 and may be arranged to be spaced apart from each other by a distance equal to or greater than a distance (e.g., a predetermined or set distance) in a winding direction w of the electrode stack 510.

In the illustrated example of FIG. 5, the first electrode tab 530_1 is disposed or located on an inner surface of the electrode stack 510 while the second electrode tab 530_2 is disposed or located on an outer surface of the electrode stack 510. However, the scope of the present disclosure is not limited thereto. For example, in an embodiment where the outer surface of the electrode stack 510 is finished or ends with the first electrode, the first electrode tab 530_1 connected to the first electrode may be disposed or located on the outer surface of the electrode stack 510. In some embodiments, both the first electrode tab 530_1 and the second electrode tab 530_2 may be disposed or located on the inner surface of the electrode stack 510.

A first electrode tab insulating member 540_1 may be attached to the first electrode tab 530_1. The first electrode tab 5301 may be positioned to overlap with the first electrode to be connected to the first electrode, and the first electrode tab insulator 5401 may be attached to cover the overlapping region between the first electrode tab 530_1 and the first electrode. The first electrode tab insulating member 5401 may be formed to be larger than the overlapping region between the first electrode tab 530_1 and the first electrode to extend beyond the overlapping region. A length d by which the first electrode tab insulating member 540_1 extends from the overlapping region may be, but is not limited to, 2 mm or greater.

Similarly, a second electrode tab insulating member 5402 may be attached to the second electrode tab 530_2. The second electrode tab 530_2 may be positioned to overlap with the second electrode to be connected to the second electrode, and the second electrode tab insulator 540_2 may be attached to cover the overlapping region between the second electrode tab 530_2 and the second electrode. The second electrode tab insulating member 5402 may be formed to be larger than the overlapping region between the second electrode tab 530_2 and the second electrode to extend beyond the overlapping region. A length by which the second electrode tab insulating member 540_2 extends from the overlapping region may be, but not limited to, 2 mm or greater.

The lower insulating members (the first and second insulating members) 520_1 and 520_2 may be attached to the lower part of the electrode stack 510. The first lower insulating member 520_1 may be attached at a distance of a first length a1 from an apex (vertex) of the first rounded portion 512_1, and the second lower insulating member 5202 may be attached at a distance of a second length a2 from an apex (vertex) of the second rounded portion 512_2. Each of the first length a1 and the second length a2 may be in a range from approximately 7 mm to approximately 8 mm, but is not limited thereto.

In one embodiment, the first lower insulating member 520_1 and the second lower insulating member 520_2 may be attached with a length (e.g., a predetermined or set length) b apart from each other in the winding direction w of the electrode stack 510. The length (e.g., the predetermined length) b between the first lower insulating member 520_1 and the second lower insulating member 520_2 may be 5 mm or greater, but is not limited thereto. The first lower insulating member 520_1 and the second lower insulating member 520_2 may be attached at positions that are symmetrical with respect to a center axis of the electrode stack 510, which is parallel to a winding axis of the electrode stack 510, but is not limited thereto.

In one embodiment, the first lower insulating member 520_1 and the second lower insulating member 520_2 may be attached to cover at least a portion of each of opposite side surfaces (e.g., front and rear surfaces) and a lower surface of the flat portion 514. For example, one end of the first lower insulating member 520_1 may be positioned on a first side surface (e.g., the front surface) of the flat portion 514 while the other end of the first lower insulating member 520_1 may be positioned on a second side surface (e.g., the rear surface) of the flat portion 514. A height c at which one end of the first lower insulating member 5201 is positioned on the first side surface of the flat portion 514 and a height at which the other end of the first lower insulating member 520_1 is positioned on the second side surface of the flat portion 514 may each be in a range from approximately 8.5 mm to approximately 9 mm, but this is not limited thereto.

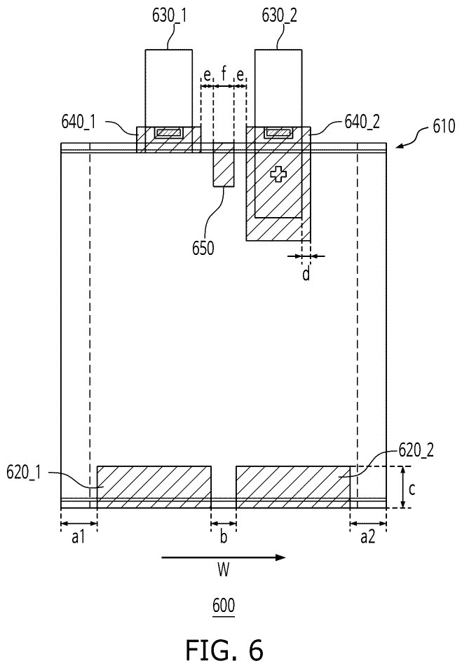

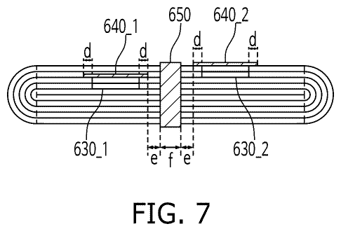

FIG. 6 illustrates a side view of an example electrode assembly 600 according to one embodiment of the present disclosure. FIG. 7 illustrates a top plan view of the example electrode assembly 600 according to one embodiment of the present disclosure. In FIGS. 6 and 7, redundant descriptions of the components previously described in FIGS. 1 to 5 will be omitted.

Referring to FIGS. 6 and 7, the electrode assembly 600 may include an electrode stack 610, lower insulating members 620_1 and 620_2 attached to the electrode stack 610, first and second electrode tabs 630_1 and 630_2 protruding beyond an upper part of the electrode stack 610, first and second electrode tab insulating members 640_1 and 640_2 respectively covering (or over) the first and second electrode tabs 630_1 and 630_2, and an upper (second) insulating member 650 disposed or located between the first electrode tab insulating member 640_1 and the second electrode tab insulating member 640_2.

In one embodiment, the upper insulating member 650 is attached to the upper part of the electrode stack 610. The upper insulating member 650 may be attached to cover at least a portion of opposite side surfaces (e.g., front and rear surfaces) and an upper surface of the electrode stack 610. For example, one end of the upper insulating member 650 is positioned on a first side surface of the electrode stack 610 while the other end of the upper insulating member 650 is positioned on a second side surface of the electrode stack 610.

In one embodiment, the upper insulating member 650 may be disposed or located between the first electrode tab insulating member 640_1 and the second electrode tab insulating member 640_2. The upper insulating member 650 may be arranged at a distance equal to or greater than a distance (e.g., a predetermined or set distance) e from each of the first and second electrode tab insulating members 640_1 and 640_2 to avoid interference with the first and second electrode tab insulating members 640_1 and 640_2. The separation distance e between the upper insulating member 650 and each of the first and second electrode tab insulating members 640_1 and 640_2 may be greater or equal to 2 mm, but is not limited thereto.

In one embodiment, a width f of the upper insulating member 650 may be formed to be smaller than the separation length b between the first lower insulating member 620_1 and the second lower insulating member 620_2. The width f of the upper insulating member 650 may be less or equal to 4 mm, but is not limited thereto. In some embodiments, the upper insulating member 650 may be attached in a position corresponding to a region between the first lower insulating member 620_1 and the second lower insulating member 620_2, where the first and second lower insulating members are spaced apart, but is not limited to this.

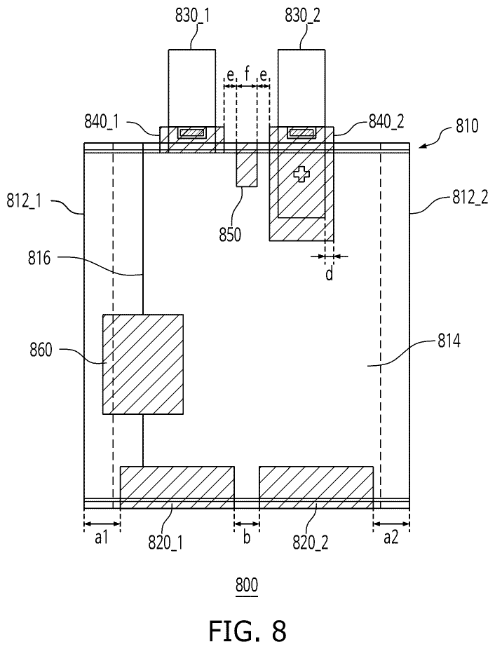

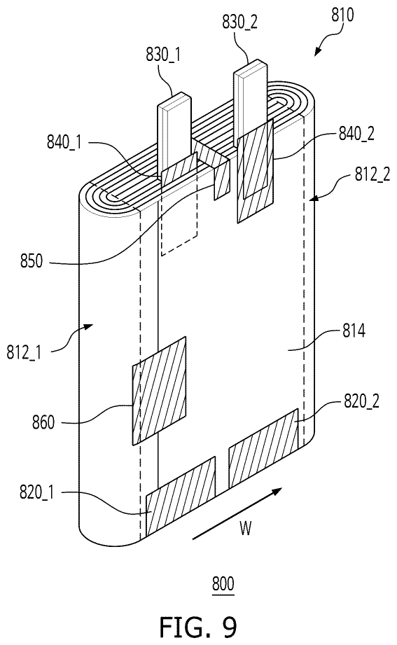

FIG. 8 illustrates a side view of an example electrode assembly 800 according to one embodiment of the present disclosure. FIG. 9 illustrates a perspective view of the example electrode assembly 800 according to one embodiment of the present disclosure. In FIGS. 8 and 9, redundant descriptions of the components previously described in FIGS. 1 to 7 will be omitted.

Referring to FIGS. 8 and 9, the electrode assembly 800 may include an electrode stack 810, lower insulating members 820_1 and 820_2 attached to the electrode stack 810, first and second electrode tabs 830_1 and 830_2 protruding beyond an upper part of the electrode stack 810, first and second electrode tab insulating members 840_1 and 840_2 respectively covering the first and second electrode tabs 830_1 and 8302, an upper insulating member 850 disposed or located between the first electrode tab insulating member 840_1 and the second electrode tab insulating member 8402, and a finishing member 860 attached to a side surface of the electrode stack 810.

The electrode stack 810 may be formed in a wound structure in which a first electrode, a separator, and a second electrode are stacked and wound together. The electrode stack 810 may include a first rounded portion 812_1 formed at a first side portion thereof, a second rounded portion 812_2 formed at a second side portion thereof, and a flat portion 814 formed between the first rounded portion 812_1 and the second rounded portion 812_2.

In one embodiment, a winding end 816 of the electrode stack 810 may be designed to be located at the flat portion 814 of the electrode stack 810. In this embodiment, the impact of stress, concentrated on opposite side portions of the electrode stack 810 due to the expansion and contraction of the electrode assembly 800, can be minimized at the winding end 816 of the electrode stack 810.

In one embodiment, the finishing member 860 may be attached to the side surface of the electrode stack 810 to secure the winding end 816 of the electrode stack 810. The finishing member 860 may be attached such that the winding end 816 of the electrode stack 810 is located at the center of the finishing member 860 along a width of the finishing member 860. However, the scope of the present disclosure is not limited thereto.

In one embodiment, the finishing member 860 may be attached to the side surface of the electrode stack 810 while being spaced apart from the lower insulating members 820_1 and 820_2 in a direction perpendicular to the winding direction w of the electrode stack 810 so as not to interfere with the lower insulating members 820_1 and 820_2. Additionally, the finishing member 860 may be attached to the side surface of the electrode stack 810 while being spaced apart from the electrode tab insulating members 840_1 and 840_2 and the upper insulating member 850 in the direction perpendicular to the winding direction w of the electrode stack 810 so as not to interfere with the electrode tab insulating members 840_1 and 840_2 and the upper insulating member 850.

FIG. 10 illustrates a table 1000 representing example internal resistance measurement results of a secondary battery according to one embodiment of the present disclosure. FIG. 11 illustrates images of a secondary battery after undergoing a crack inspection according to one embodiment of the present disclosure. Upon completion of the assembly process, the secondary battery may undergo an internal resistance/open circuit voltage (IR/OCV) test to measure the internal resistance and voltage of the battery. The results of the IR/OCV test may be used as an indicator to determine whether cracks have occurred in the electrode assembly. Through the IR/OCV test, it was found that cracks tend to occur frequently in electrode assemblies of secondary batteries with an internal resistance value ‘x’ ranging from 0.30 mΩ to 0.40 mΩ.

Referring to FIG. 10, the table 1000 shows the occurrence of cracks in the electrode assembly based on the internal resistance value x and a separation length a (for example, length a1 or a2 shown in FIG. 2) between the lower insulating member and the side edge of the electrode stack. As indicated in the table 1000, it was observed that cracks occurred in the electrode assemblies of multiple secondary batteries where the internal resistance value x ranged from 0.30 mΩ to 0.70 mΩ and the separation length a between the lower insulating member and the side edge of the electrode stack was 7.0 mm or less. In contrast, no cracks were observed in the electrode assemblies of secondary batteries where the internal resistance value x ranged from 0.30 mΩ to 0.70 mΩ and the separation length a between the lower insulating member and the side edge of the electrode stack was 7.0 mm or greater.

FIG. 11 depicts images of cracks in the electrode assemblies found by disassembling secondary batteries in which the separation length a between the lower insulating member and the side edge of the electrode stack was set to 7.0 mm or greater, and the internal resistance value x was measured to be between 0.30 mΩ and 0.5 mΩ. As the images in FIG. 11 confirm, no cracks are shown in any of the secondary batteries with the internal resistance value x ranging from 0.30 mΩ to 0.5 mΩ.

Based on the results of FIGS. 10 and 11, the attachment position of the lower insulating member can be optimized. Specifically, to prevent the occurrence of cracks in the electrode assembly, the separation length a between the lower insulating member and the side edge of the electrode stack may be designed to be no less than 7 mm. In some embodiments, as previously described above in FIG. 4, to prevent the separator from curling, the separation length a between the lower insulating member and the side edge of the electrode stack may be designed to be no greater than 8 mm. In some embodiments, the separation length a between the lower insulating member and the side edge of the electrode stack may be in a range from approximately 7 mm to approximately 8 mm.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

10: battery cell
100: electrode assembly
110: electrode stack
112: first electrode
114: second electrode
116: separator
120: lower insulating member
120_1: first lower insulating member
120_2: second lower insulating member
130: electrode tab
130_1: first electrode tab
130_2: second electrode tab
142: first lead tab
144: second lead tab
146: tab film
150: case

What is claimed is:

1. An electrode assembly comprising:
an electrode stack formed in a wound structure, the electrode stack including a first electrode, a separator, and a second electrode; and
a first insulating member and a second insulating member attached to the electrode stack,
wherein the electrode stack comprises a first side having a first rounded portion, a second side having a second rounded portion, and a third portion formed between the first rounded portion and the second rounded portion, and
the first insulating member and the second insulating member are attached to a lower part of the third portion.

2. The electrode assembly as claimed in claim 1, wherein the first insulating member is spaced apart from an apex of the first rounded portion by a first length,
the second insulating member is spaced apart from an apex of the second rounded portion by a second length, and
each of the first length and the second length is in a range from approximately 7 mm to approximately 8 mm.

3. The electrode assembly as claimed in claim 1, wherein the first insulating member and the second insulating member are attached to the electrode stack while being spaced apart from each other by a set length in a winding direction of the electrode stack.

4. The electrode assembly as claimed in claim 3, wherein the set length between the first insulating member and the second insulating member is greater or equal to 5 mm.

5. The electrode assembly as claimed in claim 1, wherein the first insulating member and the second insulating member are attached at positions that are symmetrical with respect to a central axis of the electrode stack, the central axis being parallel to a winding axis of the electrode stack.

6. The electrode assembly as claimed in claim 1, wherein the first insulating member is attached to cover at least a portion of each of opposite surfaces of the third portion and a lower surface of the third portion.

7. The electrode assembly as claimed in claim 6, wherein a first end of the first insulating member is positioned on a first surface of the opposite surfaces of the third portion at a first height from the lower surface of the third portion, and a second end of the first insulating member is positioned on a second surface of the opposite surfaces of the third portion at a second height from the lower surface of the third portion.

8. The electrode assembly as claimed in claim 7, wherein each of the first height and the second height is in a range from approximately 8.5 mm to approximately 9 mm.

9. The electrode assembly as claimed in claim 1, further comprising:
a first electrode tab and a second electrode tab that protrude beyond an upper part of the electrode stack;
a first electrode tab insulating member attached over the first electrode tab; and
a second electrode tab insulating member attached over the second electrode tab.

10. The electrode assembly as claimed in claim 9, wherein the first electrode tab insulating member and the second electrode tab insulating member are spaced apart from each other by a set length in a winding direction of the electrode stack.

11. The electrode assembly as claimed in claim 9, further comprising a second insulating member attached to cover at least a portion of each of opposite surfaces of the third portion and an upper surface of the third portion,
wherein the second insulating member is between the first electrode tab insulating member and the second electrode tab insulating member.

12. The electrode assembly as claimed in claim 11, wherein the second insulating member is located at a set distance from each of the first electrode tab insulating member and the second electrode tab insulating member in a winding direction of the electrode stack.

13. The electrode assembly as claimed in claim 12, wherein the set distance between the second insulating member and each of the first and second electrode tab insulating members is greater or equal to 2 mm.

14. The electrode assembly as claimed in claim 1, wherein at least a portion of each of the first insulating member and the second insulating member is formed of a substantially flexible material.

15. A secondary battery comprising:
an electrode assembly comprising:
an electrode stack formed in a wound structure, the electrode stack including a first electrode, a separator, and a second electrode; and
a first insulating member and a second insulating member attached to the electrode stack; and
a case accommodating the electrode assembly,
wherein the electrode stack comprises a first side having a first rounded portion, a second side having a second rounded portion, and a third portion formed between the first rounded portion and the second rounded portion, and
the first insulating member and the second insulating member are attached to a lower part of the third portion.

16. The secondary battery as claimed in claim 15, wherein the first insulating member is spaced apart from an apex of the first rounded portion by a first length,
the second insulating member is spaced apart from an apex of the second rounded portion by a second length, and
each of the first length and the second length is in a range from approximately 7 mm to approximately 8 mm.

17. The secondary battery as claimed in claim 15, wherein the first insulating member and the second insulating member are attached to the electrode stack while being spaced apart from each other by a set length in a winding direction of the electrode stack.

18. The secondary battery as claimed in claim 17, wherein the set length between the first insulating member and the second insulating member is greater or equal to 5 mm.

19. The secondary battery as claimed in claim 15, wherein the first insulating member and the second insulating member are attached at positions that are symmetrical with respect to a central axis of the electrode stack, the central axis being parallel to a winding axis of the electrode stack.

20. The secondary battery as claimed in claim 15, wherein the first insulating member is attached to cover at least a portion of each of opposite surfaces of the third portion and a lower surface of the third portion.
